(19) United States
(12) Patent Application Publication
(10) Pub. No.: US 2006/0254687 A1
(43) Pub. Date: Nov. 16, 2006

(54) Pneumatic tire with built-in sealant containing pre-hydrophobated silica

(76) Inventor: Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/126,506

(22) Filed: May 11, 2005

(51) Int. Cl. B60C 19/12; B29C 73/16

(52) U.S. Cl. 152/504

(57) ABSTRACT

The present invention relates to a pneumatic tire with a built-in depolymerized butyl rubber based sealant layer. The built-in sealant layer is of a composition comprised of a partially depolymerized butyl rubber or alternatively comprised of a polymer composite of partially depolymerized butyl rubber, together with partially depolymerized cis 1,4-polyisoprene rubber and/or partially depolymerized liquid polyisoprene polymer, which contains a pre-hydrophobated silica. The sealant layer may also contain a colorant of a non-black color which produces a built-in sealant layer of a color which contrasts with a black. Thus the sealant layer may be black in color or may be a color which contrasts with a black color. The butyl rubber-based sealant precursor is built into the tire as a layer to form a tire assembly including such sealant precursor layer wherein the butyl rubber or butyl rubber-based composite portion of the sealant precursor layer is at least partially depolymerized during a subsequent curing of the tire at an elevated temperature in a suitable mold to form the tire having the resultant built-in sealant layer. The sealant precursor composition may additionally contain conventional clay, exfoliated intercalated clay platelets, calcium carbonate and/or corn cob granule fillers.

### FIELD OF THE INVENTION

The present invention relates to a pneumatic tire with a built-in depolymerized butyl rubber based sealant layer. The built-in sealant layer is of a composition comprised of a partially depolymerized butyl rubber or alternatively comprised of a polymer composite of partially depolymerized butyl rubber, together with partially depolymerized cis 1,4-polyisoprene rubber and/or partially depolymerized liquid polyisoprene polymer, which contains a pre-hydrophobated silica. The sealant layer may also contain a colorant of a non-black color which produces a built-in sealant layer of a color which contrasts with a black. Thus the sealant layer may be black in color or may be a color which contrasts with a black color. The butyl rubber-based sealant precursor is built into the tire as a layer to form a tire assembly including such sealant precursor layer wherein the butyl rubber or butyl rubber-based composite portion of the sealant precursor layer is at least partially depolymerized during a subsequent curing of the tire at an elevated temperature in a suitable mold to form the tire having the resultant built-in sealant layer. The sealant precursor composition may additionally contain conventional clay, exfoliated intercalated clay platelets, calcium carbonate and/or corn cob granule fillers.

### BACKGROUND OF THE INVENTION

Various pneumatic tires have been proposed which contain a built-in sealant layer based upon a depolymerized butyl rubber layer.

For example, in U.S. Pat. No. 4,895,610 it is proposed to build a layer of butyl rubber-based composition into a tire which contains a polyisobutylene polymer and an organoperoxide, following which under a condition of elevated temperature used to cure the tire, a major portion of the butyl rubber is presented as being depolymerized to form a tacky material which has puncture sealant properties.

U.S. Pat. Nos. 4,228,839, 4,171,237 and 4,140,167 also relate to a sealant layer in a tire formed by depolymerizing and crosslinking a butyl rubber-based rubber composition, particularly by irradiation treatment.

U.S. Patent Application Publication No. 2005/0034799 A1 relates to a tire with built-in sealant comprised of a partially depolymerized butyl rubber via an organoperoxide which contains a dispersion of particulate pre-cured rubber particles.

U.S. patent application Ser. No. 10/368,259, filed Feb. 17, 2003, relates to a tire with built-in sealant comprised of a partially depolymerized butyl rubber via an organoperoxide which contains a particulate filler comprised of carbon black and/or coal dust and, optionally short fibers, hollow glass microspheres and rubber processing oil wherein the sealant may also contain a liquid diene-based polymer.

U.S. Patent Application Publication No. 2005/0034799 A1 relates to a self sealing tire containing a sealing material which may be contained within the tire and which may be comprised of a thermally degraded butyl rubber with an organic peroxide and containing a reinforcing filler.

Additional patents which relate to various tire constructions which may involve built-in or built-on sealants for tires such as for example, U.S. Pat. Nos. 1,239,291, 2,877,819, 3,048,509, 3,563,294, 4,206,796, 4,286,643, 4,359,078, 4,444,294, 4,895,610, 4,919,183 and 4,966,213.

Fillers such as exfoliated, intercalated water swellable clays, particularly exfoliated clay platelets, may be referred to herein as nanoclays derived from water swellable clays such as for example montmorillonite, hectorite and vermiculite clays or their mixtures. For example, see U.S. Pat. Nos. 6,598,645 and 6,858,665. Such exfoliated clays platelets are intended to be differentiated from conventional clays, such as for example kaolin clays which would not be expected to be in an exfoliated platelet form.

Pre-treated (pre-hydrophobated) as precipitated silicas pre-treated with non-silane coupling agents have been reported as being, for example, tetrathiodipropionic acid (U.S. Pat. No. 6,458,882) and 2-hydroxyethyl methacrylate (U.S. Pat. No. 6,528,592) as well as U.S. Pat. No. 5,555,609 (thioglycerol and benzothiazyl disulfide) and U.S. Pat. No. 6,713,549.

Pre-treated (pre-hydrophobated) as precipitated silicas pre-treated with various alkoxysilanes (including organomercaptoalkoxysilanes having the mercapto moiety capped or uncapped) are reported in U.S. Pat. Nos. 5,719,207, 5,780,538, 5,914,364, 6,573,324 and U.S. Patent Application Publication No. 2005/0009951 A1 (and including a vinylalkoxysilane reported as a VP Coupsil™ 6508 by Degussa A. G. in its product bulletin PA 701 “Organosilane”, with the “VP” designation reported as being experimental.

In one aspect, the various built-in sealant layers for the pneumatic tires which are derived from a depolymerization of a butyl rubber-based sealant precursor composition typically contain a rubber reinforcing carbon black filler and are therefore black in color.

For this invention, it is desired to provide a built-in sealant layer for a pneumatic tire which is derived from a depolymerization of a butyl rubber-based sealant precursor composition which is of a black color (resulting from an inclusion of carbon black) or a color other than black (resulting from an inclusion of a colorant with a minimal, if any carbon black content), where the sealant of other than black color may be used as an aid to identify a puncture wound in a carbon black reinforced innerliner, tread and/or sidewall of said tire, depending somewhat upon the position of the built-in sealant layer, because of its contrasting color. Therefore, in one aspect, it is envisioned that such a non-black colored sealant layer is substantially exclusive of carbon black and particularly substantially exclusive of a rubber reinforcing carbon black. By the term “substantially exclusive of” carbon black it is intended that only a minimal amount, preferably none, of carbon black is present such as, for example, an impurity amount (e.g. less than about 0.1 phr) of carbon black, alternately an amount of up to about 2, preferably less than about 0.5, phr of carbon black, may be present so long as the sealant layer is of a color other than black and preferably contrasting with black colored (carbon black reinforcement containing) tire components which adjoin the built in sealant layer such as, for example, a tire innerliner component.

In practice, built-in sealants for tires based upon organoperoxide depolymerized butyl rubber have heretofore, in general, relied upon containing rubber reinforcing carbon black to provide a degree of reinforcement and thereby a suitable rubber viscosity to enable the sealant precursor composition to be conveniently processable both by formation into a suitable rubber sheet whether by extrusion or calendering and, also, by handling to build a sheet, or layer, of the sealant precursor composition into a tire assembly. Further, the presence of the rubber reinforcing carbon black is relied upon to provide a suitable viscosity of the built-in sealant in order to promote the stability of the sealant composition.

However, for this invention, synthetic, amorphous silica (aggregates of primary silica particles), preferably in the form of a precipitated silica, is used as a primary reinforcing filler for the butyl rubber-based sealant precursor composition instead of rubber reinforcing carbon black so that a colorant other than of a black color may be effectively used to color the sealant layer.

In another aspect of the invention, a portion of the precipitated silica may be replaced by fillers such as, for example, clay, for example kaolin clay, calcium carbonate the aforesaid corn cob granules and/or the aforesaid exfoliated, intercalated clays for which, therefore, the butyl rubber-based sealant precursor may contain one or more of such fillers in addition to the precipitated silica.

However, such fillers are not considered herein as being as effective reinforcing ingredients for the butyl rubber based rubber composition as the aforesaid precipitated silica which is in a form of said pre-hydrophobated silica. Accordingly, only a partial replacement of the pre-hydrophobated silica with such filler(s) is contemplated.

Significant challenges are presented in the use of the synthetic, amorphous silica, particularly precipitated silica, as well as the inclusion of the aforesaid additional fillers.

For example, contrary to rubber reinforcing carbon black, such precipitated silica, (e.g. precipitated silica aggregates of primary silica particles), normally contains a significant presence of water of hydration, and/or water of association on its surface as well as a significant presence of hydroxyl groups (e.g. silanol groups). The clay and calcium carbonate may also contain an associated water moiety.

While the mechanism may not be fully understood, it is envisioned that at least a portion of such water, and possibly a portion of such hydroxyl groups, is available to prematurely decompose the organoperoxide intended to be used to depolymerize the butyl rubber in the sealant precursor composition.

It is considered herein that such premature decomposition of the organoperoxide, whether by presence of the water of hydration and/or association or by the presence of the hydroxyl groups, may adversely affect the free radical generating activity of the organoperoxide for a timely depolymerization of the butyl rubber after the sealant precursor layer is built into the tire assembly and the tire is cured at an elevated temperature. Such prematurely formed free radicals may become associated with the silica, and possibly the clay and calcium carbonate, rather than be involved with the desired depolymerization of the butyl rubber. It is further envisioned that if excess organoperoxide is added to allow for such premature decomposition, a portion of such excess organoperoxide may later or otherwise gradually become available to interact with associated rubber layers of the tire assembly, or construction, adjacent to the built-in sealant.

For this invention, to inhibit, retard and/or significantly prevent significant contact of such water moieties and hydroxyl groups of the amorphous silica aggregates (precipitated silica) with the organoperoxide, the synthetic amorphous silica is pre-treated (pre-hydrophobated) prior to its addition to the butyl rubber based sealant composition.

An important aspect of this invention is providing a pneumatic tire with a built-in black or non-black sealant layer positioned (sandwiched) between dimensionally stable sulfur vulcanized rubber layers (e.g. between a tire inner liner rubber layer and tire carcass) which promotes sealing against an externally puncturing object to prevent, or significantly retard, leakage of gas (e.g. air) from the tire cavity through the puncture to the outside of the tire by allowing the pressure within the tire cavity (air pressure greater than ambient atmospheric pressure) to press the sealant against the puncturing object or the cavity caused by the puncturing object.

In the description of this invention, the term “phr” is used to designate parts by weight of an ingredient per 100 parts of elastomer unless otherwise indicated. The terms “elastomer” and “rubber” are used interchangeably unless otherwise indicated. The terms “cure” and “vulcanize” are used interchangeably unless otherwise indicated.

### SUMMARY AND PRACTICE OF THE INVENTION

In accordance with this invention, a pneumatic rubber tire having a built-in puncture sealing layer is provided;

wherein said puncture sealing layer contains an at least partially organoperoxide-depolymerized polymer-based sealant layer, (normally positioned between a carbon black reinforced tire innerliner layer often of a halobutyl rubber composition, and tire carcass, or between two tire innerliner rubber layers, and therefore covered by at least one tire innerliner rubber layer), wherein said puncture sealing layer is comprised of, based upon parts by weight per 100 parts by weight partially depolymerized polymer comprised of butyl rubber or a composite of butyl rubber and at least one of cis 1,4-polyisoprene rubber or liquid cis 1,4-polyisoprene polymer or their mixture (phr):

(A) organoperoxide partially depolymerized polymer comprised of:
(1) a first organoperoxide partially depolymerized rubber as an organoperoxide partially depolymerized butyl rubber, or
(2) a second organoperoxide partially depolymerized composite polymer network comprised of:
   (a) about 50 to about 95 parts by weight organoperoxide partially depolymerized butyl rubber, and
   (b) about 5 to about 50 parts by weight at least one of organoperoxide partially depolymerized cis 1,4-polyisoprene elastomer and organoperoxide partially depolymerized liquid cis 1,4-polyisoprene polymer and their mixtures:

wherein said butyl rubber is a copolymer comprised of isobutylene and isoprene comprised of about 0.5 to about 5, preferably within a range of from 0.5 to one, percent units derived from isoprene, and correspondingly from about 95 to about 99.5, preferably within a range of from 99 to 99.5, weight percent units derived from isobutylene,

wherein said cis 1,4-polyisoprene elastomer is a natural or synthetic cis 1,4-polyisoprene rubber having a cis 1,4-isomeric content of at least 95 percent,

wherein said liquid cis 1,4-polyisoprene polymer is a partially depolymerized natural or synthetic cis 1,4-polyisoprene rubber having a cis 1,4-isomeric content of at least 95.

(B) about 25 to about 100, alternately about 30 to about 75, phr particulate reinforcing filler comprised of:
(1) about 25 to about 100, alternately from 30 to 75 phr of precipitated silica (synthetic amorphous silica), and from zero up to about 5, preferably about zero, phr of carbon black, so long as said sealant layer is of a non-black color,
wherein said carbon black is preferably a rubber reinforcing carbon black, or;
(2) about 5 to about 50 phr of precipitated silica and from 10 to about 50 phr of carbon black so long as the sealant layer is of a black color, wherein said carbon black is preferably a rubber reinforcing carbon black;
(3) from zero to 20, alternately from 5 to 15, phr of additional filler comprised of clay preferably kaolin clay, calcium carbonate, corn cob granules, or exfoliated intercalated water swellable clay platelets or their mixtures;

(C) from zero to 6, alternately about 0.5 to about 5, phr of short organic fibers;

(D) optionally a colorant of other than a black color (particularly where it is desired that said sealant layer is of a non-black color) wherein said colorant is comprised of at least one of organic pigments, inorganic pigments and dyes, preferably from organic pigments and inorganic pigments;

(E) from zero to about 20, alternately about 2 to about 15, phr of rubber processing oil, preferably a rubber processing oil having a maximum aromatic content of about 15 weight percent, and preferably a naphthenic content in a range of from about 35 to about 45 weight percent and preferably a paraffinic content in a range of about 45 to about 55 weight percent.

wherein said precipitated silica is comprised of:
(1) a pre-hydrophobated precipitated silica, or
(2) a combination of from about 5 to about 50 phr of pre-hydrophobated precipitated silica and from about 5 to about 50 phr of non pre-hydrophobated precipitated silica;

wherein, for said sealant layer comprised of said first, A(1), organoperoxide partially depolymerized rubber, said pre-hydrophobated precipitated silica is pre-hydrophobated by treatment of a precipitated silica with:
(3) a non-silane containing compound comprised of:
   (a) dithiodipropoinic acid,
   (b) trithiodipropionic acid,
   (c) tetrathiodipropionic acid,
   (d) 2-hydroxyethyl methacrylate,
   (f) thioglycerol,
   (g) benzothiazyl disulfide, or
(4) a combination of at least one of said non-silane containing compounds and an alkoxysilane containing compound comprised of at least one of an organoalkoxysilane compound and organomercaptoalkoxysilane compound,
wherein for said second, A(2), organoperoxide partially depolymerized composite, said pre-hydrophobated precipitated silica is pre-hydrophobated by treatment of precipitated silica prior to addition of said organoperoxide either in situ within the rubber composition or by pre-treatment of said silica prior to its addition to the rubber composition (butyl rubber in combination with said cis 1,4-polyisoprene rubber and/or liquid cis 1,4-polyisoprene rubber) to inhibit adsorption or absorption of said organoperoxide on the surface of said silica, for example by treatment of said silica with
   (a) said non-silane containing compound,
   (b) an alkoxysilane containing compound comprised of at least one of an organoalkoxysilane compound and organomercaptoalkoxysilane compound,
   (c) a combination of at least one of said of said non-silane containing compounds and said alkoxysilane containing compounds, or
   (d) a bis(3-trialkoxysilylalkyl)polysulfide having an average of from 2 to about 4, alternately an average of from about 2 to about 2.6 or an average of from about 3.4 to about 3.8, connecting sulfur atoms in its polysulfidic bridge.

The cis 1,4-polyisoprene elastomer and liquid cis 1,4-polyisoprene polymer, as well as the butyl rubber, can undergo a chain scission in the presence of the organoperoxide, and therefore at least a partial depolymerization.

In practice, the composite of butyl rubber together with the cis 1,4-polyisoprene rubber and/or liquid cis 1,4-polyisoprene polymer are treated as a singular composition by the organoperoxide in a manner that the butyl rubber, cis 1,4-polyisoprene rubber and/or liquid cis 1,4-polyisoprene polymer are co-partially depolymerized together by the organoperoxide to form a partially depolymerized polymer composite.

A significant aspect of the inclusion of the organoperoxide partially depolymerized cis 1,4-polyisoprene elastomer as a component of the organoperoxide depolymerized butyl rubber based sealant network composite is to promote an improved interaction between the treated precipitated silica and the depolymerized polymer composite network based upon the relatively higher unsaturation of the polyisoprene polymer (significantly higher than the unsaturation content of the butyl rubber).

A significant aspect of the inclusion of the organoperoxide partially depolymerized liquid cis 1,4-polyisoprene polymer as a component of the butyl rubber based sealant network composite is to promote an improved ability to adjust, or manipulate, the sealant viscosity.

In practice, said sealant layer is positioned between a carbon black reinforced innerliner and tire carcass, or between two carbon black reinforced tire innerliners, and wherein said tire has a carbon black reinforced tread and sidewall.

A significant aspect of the invention is, for example, where the sealant is of a non-black color, is the use of such sealant as an aid to:

(A) identify a puncture wound in a carbon black reinforced rubber innerliner, crown region, tread and/or sidewall of said tire, and/or

(B) identify the presence of the built-in non-black colored sealant in the tire, such as for example, in a tire retreading operation to physically detect the presence of the built-in sealant by its visually contrasting non-black colored appearance in the case of an open wound in a carbon black reinforced rubber innerliner or by a relatively softness of the rubber innerliner layer itself as a result of the associated underlying built-in sealant layer.

Accordingly, in an additional accordance with this invention, the tire is provided as having said non-black colored built-in sealant layer having the capability of visibly identifying a puncture wound which extends through a black colored carbon black reinforced tire rubber innerliner layer, black colored carbon black reinforced tire rubber tread and/or black colored carbon black reinforced tire rubber sidewall layer to said built-in sealant layer by a physical flow of a portion of said non-black colored built-in sealant layer through said puncture wound to form a contrastingly non-black colored sealant on a visible surface of said black colored carbon black reinforced innerliner, tread or sidewall.

In practice, representative of said alkoxysilanes are, for example, trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

In practice, various conventional clays may be used. Representative of such clays are, for example, kaolin clays. It is envisioned herein that a benefit of utilization of such conventional clay is to provide a modified, or tempered, degree of reinforcement, as compared to the silica, for the sealant precursor composition to aid in its aforesaid processing and also to aid, in combination with the silica, in providing a suitable stiffness and associated dimensional integrity for the partially depolymerized butyl rubber-based sealant composition.

In practice, exfoliated, intercalated water swellable clays can be used in which a significant portion of the clay is present in a form of exfoliated clay platelets. Representative of such clays are, for example, montmorillonite clays and hectorite clays as well as vermiculite for a purpose of also adding a degree of reinforcement.

In practice, the calcium carbonate may also be used. As with the aforesaid conventional clays and exfoliated clay platelets, it is envisioned that a benefit of utilization of such calcium carbonate is to provide a modified, or tempered, degree of reinforcement, as compared to the silica, for the sealant precursor composition to aid in its aforesaid processing and also to aid, in combination with the silica, in providing a suitable stiffness, and associated dimensional integrity for the partially depolymerized butyl rubber-based sealant composition.

For this invention, various synthetic amorphous silicas may be used in a form of a precipitated silica, which may be used to prepare the pre-hydrophobated silica representative of which are, for example and not intended herein to be limitative, HiSil 532™ from PPG Industries, Hubersil 4155™ from the J. M. Huber Company and Ultrasil™ VN2 and VN3 from the Degussa Company.

Such precipitated silicas are silica aggregates which are considered herein to be in an agglomerated (compacted) form with relatively very low BET (nitrogen) surfaces areas (e.g. reportedly about 60 m²/g for the HiSil 532™ and Hubersil 4155™ silica aggregates, provided in an agglomerated form).

A method of measuring BET (nitrogen) surface area of precipitated silicas is ASTM D 1993-91, Standard Test Method for Precipitated Silica-Surface Area by Multipoint BET Nitrogen Adsorption which relates to the conventional theory described by Brunauer, Emmett and Teller in the Journal of the American Chemical Society, Volume 60, (1938), Page 309.

The optional various rubber processing oils are well known to those having skill in such art. For this invention, a rubber processing oil having a low aromaticity content is preferred, namely a rubber processing oil having an aromaticity content of less than about 15 weight percent. Such a preferred rubber processing oil may be composed of, for example, about 35 to about 45 weight percent naphthenic content, about 45 to about 55 weight percent paraffinic content and an aromatic content of less than about 15 weight percent (e.g. from about 10 to about 14 weight percent). It is considered herein that a representative of such preferred rubber processing oil is Tufflo 100™ from the Barton Solvent Company. The rubber processing oil, in relatively low concentrations, is seen herein to aid in mixing the ingredients for the sealant precursor composition and to aid in promoting the aforesaid processing of sealant precursor composition.

The optional short fibers may be selected from, for example, cotton fibers and from synthetic fibers selected from rayon, aramid, nylon and polyester fibers, and their mixtures. In practice, such cotton short fibers may have an average length, for example, in a range of up to about 200 microns (e.g. an average length of about 150 microns) and the synthetic (e.g. the polyester and nylon fibers) may have an average length, for example, of up to a maximum of about 2,500 microns. The short fibers are considered herein to aid in promoting the effectiveness of the sealing ability of the resultant sealant composition. In relatively low concentrations, such synthetic fibers are not seen herein as significantly interfering with the processing of the sealant precursor composition yet as promoting the effectiveness of the resultant built-in sealant layer for its puncture sealing ability.

In practice, the colorant may be comprised of titanium dioxide. For example, the colorant of such sealant composition may preferably be composed of titanium dioxide where a white colored sealant layer is desired. Also, such colorant may contain, or be comprised, of titanium dioxide as a color brightener together with at least one non-black organic pigment and/or non-black inorganic pigment or dye.

Various colorants may be used to provide a non-black color to the sealant and sealant precursor composition. Representative of such colorants are, for example, yellow colored colorants as Diarylide Yellow™ pigment from PolyOne Corporation and Akrosperse E-6837™ yellow EPMB pigment masterbatch with an EPR (ethylene/propylene rubber) from the Akrochem Company. As discussed above, such colorant may be used in combination with titanium dioxide with the titanium dioxide being somewhat of a brightener for the colorant.

Various organoperoxides may be used for the sealant precursor butyl rubber-based composition. Preferably organoperoxides are used which become active (e.g. generate peroxide free radicals) at high temperatures, that is, for example, above about 100° C. Such organoperoxides are referred to therein as active peroxides. Examples of such organoperoxides which are considered herein as being active organoperoxides are, for example, tertbutyl perbenzoate and dialkyl peroxides with the same or different radicals, such as dialkylbenzene peroxides and alkyl pre-esters. Preferably the active organoperoxide will contain two peroxide groups. Frequently the peroxide groups are attached to a tertiary butyl group. The basic moiety on which the two peroxide groups are suspended can be aliphatic, cycloaliphatic, or aromatic radicals. Some representative examples of such active organoperoxides are, for example, n-butyl 4,4-di-(tert-butylperoxy)valerate, 2,5-bis(t-butyl peroxy)-2,5-dimethyl hexane; 1,1-di-t-butyl peroxi-3,3,5-trimethyl cyclohexane; 2,5-dimethyl-2,5-di(t-butyl peroxy)hexyne-3; p-chlorobenzyl peroxide; 2,4-dichlorobenzyl peroxide; 2,2-bis-(t-butyl peroxi)-butane; di-t-butyl peroxide; benzyl peroxide; 2,5-bis(t-butyl peroxy)-2,5-dimethyl hexane, dicumyl peroxide; and 2,5-dimethyl-2,5-di(t-butyl peroxy)hexane. The n-butyl 4,4-di-(tert-butylperoxy)valerate may be a preferred organoperoxide for use in the depolymerizing of the butyl rubber or composite of butyl rubber together with cis 1,4-polyisoprene rubber and/or liquid cis 1,4-polyisoprene polymer of the butyl rubber containing sealant precursor.

Such organoperoxide may be provided on a mineral carrier such as, for example calcium carbonate or a combination of calcium carbonate and calcium silicate. For example, the n-butyl 4,4-di-(tert-butylperoxy)valerate may be provided as a composite with a mineral carrier. Such mineral carrier may be, for example, combination of calcium carbonate and calcium silicate such as, for example, as Trigonox 17-40B-pd™ from the Akzo Nobel Polymer Chemicals LLC Company.

Thus, such active organoperoxides may be added to the sealant precursor butyl rubber-based composition layer usually as a composite with an inert, free-flowing mineral carrier, such as, for example, calcium carbonate. The organoperoxide as a composite thereof with a mineral carrier, such as for example calcium carbonate, is preferred for storing the peroxide and handling and processing. Such composite may be composed of, for example, from about 35 to 60 weight percent of the active organoperoxide.

In practice, a pneumatic tire having a puncture sealing ability comprised of an assembly of components comprised of an outer circumferential (sulfur curable) rubber tread, (sulfur curable) rubber carcass supporting said tread and an inner layer, may be prepared by, for example:

(A) positioning a layer of said uncured butyl rubber-based rubber composition, exclusive of sulfur curative, as a sealant layer precursor between said innerliner and rubber carcass barrier layer,

(B) vulcanizing said tire assembly in a suitable mold at a temperature in a range of from about 130° C. to about 175° C. for a sufficient period of time to partially depolymerize said butyl rubber or said composite of butyl rubber together with at least one of cis 1,4-polyisoprene rubber and liquid cis 1,4-polyisoprene polymer and thereby form a built-in sealant layer.

In practice, it is conventionally preferred that the butyl rubber, or combination of butyl rubber and at least one of cis 1,4-polyisoprene rubber and liquid cis 1,4-polyisoprene polymer, and pre-hydrophobated silica are blended in at least one sequential preparatory, or non-productive, mixing stage in the absence of the organoperoxide followed by a final, or productive, mixing stage in which the organoperoxide (and possibly one or more of the additional ingredients) is added.

Conventionally, the non-productive mixing stage(s) may be conducted, for example, by mixing the ingredients to a temperature in a range of from about 110 to about 150° C. and the subsequent productive mixing stage may be conducted, for example, by mixing the ingredients to a temperature in a range of from about 85 to about 100° C.

A significant aspect of this invention is the at least partial depolymerization of the butyl rubber-based sealant precursor layer built into the tire (between the tire innerliner and tire carcass) during the vulcanization of the tire itself in a suitable mold at an elevated temperature via an organoperoxide in the presence of the said pre-hydrophobated precipitated silica which may optionally include clay and/or calcium carbonate to create the built-in colored puncture sealant layer.

This is considered herein to be significant because said butyl rubber-based sealant precursor composition is conveniently processable as a rubber composition which can be suitably built as a rubber layer into a tire.

In practice, upon vulcanization of the tire assembly under conditions of elevated temperature, a major portion of the uncured butyl rubber composition is considered herein to be depolymerized in the presence of the organoperoxide compound to form a tacky material.

In practice, said tire innerliner halobutyl rubber-based layer is typically a sulfur curative-containing halobutyl rubber composition of a halobutyl rubber such as for example chlorobutyl rubber or bromobutyl rubber.

Such tire halobutyl rubber-based innerliner layer may also contain one or more sulfur curable diene-based elastomers such as, for example, cis 1,4-polyisoprene natural rubber, cis 1,4-polybutadiene rubber and styrene/butadiene rubber, and their mixtures, or more preferably a combination of one or more of said halobutyl rubbers and said diene based elastomers.

As the tire is vulcanized together with the butyl rubber-based rubber composition layer (the sealant layer precursor) sandwiched between the tire carcass and the tire's rubber innerliner, the butyl rubber of the butyl rubber-based composition layer which is to become the sealant layer, becomes partially depolymerized.

In effect, the butyl rubber or combination of butyl rubber together with the cis 1,4-polyisoprene rubber and/or cis 1,4-liquid polyisoprene polymer in the butyl rubber based composition sealant layer is transformed into a puncture sealant layer during the curing of the tire. This at least partial depolymerization of the butyl rubber-based composition layer is effected by the presence of the one or more free radical-generating organoperoxides contained in the butyl rubber sealant precursor composition.

The various components of the sealant layer can be mixed together using convenient rubber mixing equipment, particularly an internal rubber mixer. The rubber composition used in the sealant precursor layer typically has sufficient viscosity and unvulcanized tack to enable its incorporation into an unvulcanized tire without significantly departing from conventional tire building techniques.

In an exemplary method of this invention, the butyl rubber-based sealant precursor composition can be formed into a rubber strip by using conventional equipment such as a calender, extruder, or any combination thereof, and the rubber strip assembled into the tire. In building the tires of this invention a rubber innerliner of a butyl rubber based (e.g. bromobutyl rubber) rubber composition is first applied to a building drum and then the strip of butyl rubber based sealant precursor layer is applied to the layer of innerliner and thereafter the remainder of various carcass plies and layers of the tire assembly. The butyl rubber based sealant precursor layer is thereby assembled into the unvulcanized tire assembly of components between an innerliner layer and tire carcass.

The built-in sealant layer may, for example, be positioned between a tire innerliner rubber layer and tire carcass or between two tire innerliner rubber layers wherein said sealant layer may:

(A) extend from one shoulder of the tire to the other through the crown region of the tire;

(B) be positioned in at least one tire shoulder area region and extend into at least a portion of the adjoining tire sidewall portion of the tire, or

(C) extend from sidewall-to-sidewall through the tire crown region.

The thickness of the sealant composition layer can vary greatly in an unvulcanized puncture sealant containing tire. Generally, the thickness of the sealant composition layer may range from about 0.13 cm (0.05 inches) to about 1.9 cm (0.75 inches). In passenger tires it is normally desired for the sealant composition layer to have a thickness of about 0.32 cm (0.125 inches) whereas for truck tires, a thickness of about 0.76 cm (0.3 inches) or greater might be desired.

After the unvulcanized pneumatic rubber tires of this invention are assembled they are vulcanized using a normal tire cure cycle. The tires of this invention can be cured over a wide temperature range. For example, passenger tires might be cured at a temperature ranging from about 130° C. to about 170° C. and truck tires might be cured at a temperature ranging from about 130° C. to about 170° C. Thus, a cure temperature may range, for example, from about 130° C. to about 170° C. and for a period of time (e.g. from about 10 to about 45 minutes or more depending somewhat upon the size of the tire and the degree of desired depolymerization of the butyl rubber as well as the thickness of the sealant layer itself) and sufficient to at least partially depolymerize said sealant precursor layer.

Accordingly, in one aspect of the invention, a self-sealing pneumatic rubber tire of this invention is envisioned wherein the tire has sidewalls, a supporting carcass, inextensible beads, an innerliner (air barrier layer), a sealant layer, and an outer circumferential tread (tread portion). The individual sidewalls extend radially inward from the axial outer edges of the tread portion to join the respective inextensible beads.

The supporting carcass acts as a supporting structure for the tread portion and sidewalls.

The sealant layer is disposed between said supporting carcass and said innerliner. The outer circumferential tread is adapted to be ground contacting when the tire is in use.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic rubber tire having a built-in puncture sealing layer comprised of, based upon parts by weight per 100 parts by weight partially depolymerized polymer comprised of butyl rubber or a composite of butyl rubber and at least one of cis 1,4-polyisoprene rubber or liquid cis 1,4-polyisoprene polymer or their mixture (phr):
(A) organoperoxide partially depolymerized polymer comprised of:
(1) a first organoperoxide partially depolymerized rubber as an organoperoxide partially depolymerized butyl rubber, or
(2) a second organoperoxide partially depolymerized composite polymer network comprised of:
(a) about 50 to about 95 parts by weight organoperoxide partially depolymerized butyl rubber, and
(b) about 5 to about 50 parts by weight at least one of organoperoxide partially depolymerized cis 1,4-polyisoprene elastomer and organoperoxide partially depolymerized liquid polyisoprene polymer and their mixtures:
wherein said butyl rubber is a copolymer comprised of isobutylene and isoprene comprised of about 0.5 to about 5, preferably within a range of from 0.5 to one, percent units derived from isoprene, and correspondingly from about 95 to about 99.5, preferably within a range of from 99 to 99.5, weight percent units derived from isobutylene,
wherein said cis 1,4-polyisoprene elastomer is a natural or synthetic cis 1,4-polyisoprene rubber having a cis 1,4-isomeric content of at least 95 percent,
wherein said liquid cis 1,4-polyisoprene polymer is a partially depolymerized natural or synthetic cis 1,4-polyisoprene rubber having a cis 1,4-isomeric content of at least 95 percent,
(B) about 25 to about 100 phr particulate reinforcing filler comprised of:
(1) about 25 to about 100 phr of precipitated silica and from zero up to about 5, preferably about zero, phr of carbon black, so long as said sealant layer is of a non-black color or;
(2) about 5 to about 50 phr of precipitated silica and from 10 to about 50 phr of carbon black so long as the sealant layer is of a black color;
(3) from zero to about 20 phr of additional filler comprised of clay preferably kaolin clay, calcium carbonate, corn cob granules, or exfoliated intercalated water swellable clay platelets or their mixtures;
(C) from zero to about 6 phr of short organic fibers;
(D) optionally a colorant of other than a black color, wherein said colorant is comprised of at least one of organic pigments, inorganic pigments and dyes;
(E) from zero to about 20 phr of rubber processing oil;
wherein said precipitated silica is comprised of:
(1) a pre-hydrophobated precipitated silica, or
(2) a combination of from about 5 to about 50 phr of pre-hydrophobated precipitated silica and from about 5 to about 50 phr of non pre-hydrophobated precipitated silica;
wherein, for said sealant layer comprised of said first, A(1), organoperoxide partially depolymerized rubber, said pre-hydrophobated precipitated silica is prpovided by treatment of a precipitated silica with:
(3) a non-silane containing compound comprised of:
(a) dithiodipropoinic acid,
(b) trithiodipropionic acid,
(c) tetrathiodipropionic acid,
(d) 2-hydroxyethyl methacrylate,
(e) thioglycerol,
(f) benzothiazyl disulfide, or
(g) a combination of at least one of said non-silane containing compounds and an alkoxysilane containing compound comprised of at least one of an organoalkoxysilane compound and organomercaptoalkoxysilane compound,
wherein for said second, A(2), organoperoxide partially depolymerized composite, said pre-hydrophobated precipitated silica is provided by treatment of precipitated silica prior to addition of said organoperoxide either in situ within the rubber composition or by pre-treatment of said silica prior to its addition to the rubber composition (butyl rubber in combination with said cis 1,4-[polyisoprene rubber and/or liquid cis 1,4-polyisoprene rubber) to inhibit adsorption or absorption of said organoperoxide on the surface of said silica.

2. the tire of claim 1 wherein, for said built-in sealant for said section A(2) organoperoxide partially depolymerized composite, said pre-hydrophobated precipitated silica is provided by treatment of precipitated silica with
(A) said non-silane containing compound,
(B) an alkoxysilane containing compound comprised of at least one of an organoalkoxysilane compound and organomercaptoalkoxysilane compound,
(C) a combination of at least one of said of said non-silane containing compounds and said alkoxysilane containing compounds, or
(D) a bis(3-trialkoxysilylalkyl)polysulfide having an average of from 2 to about 4, alternately an average of from about 2 to about 2.6 or an average of from about 3.4 to about 3.8, connecting sulfur atoms in its polysulfidic bridge.

3. The tire of claim 1 wherein said built-in sealant layer is positioned between a tire innerliner rubber layer and tire carcass or between two tire innerliner rubber layers.

4. The tire of claim 3 wherein said built-in sealant layer extends from sidewall-to-sidewall portions of the tire through the tire crown region.

5. The tire of claim 3 wherein said tire innerliner layer(s) is comprised of a halobutyl based rubber composition.

6. The tire of claim 1 wherein said built-in sealant layer contains from 5 to 15 phr of said additional filler comprised of clay, calcium carbonate, corn cob granules, or exfoliated intercalated water swellable clay platelets or their mixtures.

7. The tire of claim 6 wherein said additional filler is comprised of said corn cob granules.

8. The tire of claim 6 where said additional filler is comprised of said exfoliated clay platelets.

9. The tire of claim 1 wherein built-in sealant layer contains from about 30 to about 75 phr particulate reinforcing filler comprised about 30 to about 75 phr of precipitated silica and from zero up to about 5 phr of carbon black, so long as said sealant layer is of a non-black color, and further contains from 5 to 15 phr of additional filler comprised of clay, calcium carbonate, corn cob granules, or exfoliated intercalated water swellable clay platelets or their mixtures.

10. The tire of claim 1 wherein said additional filler is comprised of at least one of said corn cob granules and exfoliated clay platelets or their mixtures.

11. The tire of claim 1 wherein said pre-hydrophobated silica is a precipitated silica having been pre-hydrophobated prior to mixing with said sealant precursor composition.

12. The tire of claim 1 wherein said pre-hydrophobated silica is a precipitated silica having been pre-hydrophobated in situ within said sealant precursor composition prior to addition of said organoperoxide.

13. The tire of claim 1 wherein said organoperoxide is comprised of at least one of n-butyl 4,4-di-(tert-butylperoxy)valerate, 2,5-bis(t-butyl peroxy)-2,5-dimethyl hexane; 1,1-di-t-butyl peroxi-3,3,5-trimethyl cyclohexane; 2,5-dimethyl-2,5-di(t-butyl peroxy)hexyne-3; p-chlorobenzyl peroxide; 2,4-dichlorobenzyl peroxide; 2,2-bis-(t-butyl peroxi)-butane; di-t-butyl peroxide; benzyl peroxide; 2,5-bis(t-butyl peroxy)-2,5-dimethyl hexane, dicumyl peroxide; and 2,5-dimethyl-2,5-di(t-butyl peroxy)hexane.

14. The tire of claim 1 wherein said organoalkoxysilane is comprised of at least one of trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

15. The tire of claim 1 wherein said colorant is comprised of at least one of titanium dioxide, non-black organic pigment, and non-black inorganic pigment or dye.

16. The tire of claim 1 wherein said rubber processing oil has an aromaticity content of less than about 15 weight percent.

17. The tire of claim 1 wherein said built-in puncture sealing layer is comprised of, based upon parts by weight per 100 parts by weight partially depolymerized butyl rubber (phr) of an organoperoxide partially depolymerized butyl rubber;
wherein said particulate reinforcing filler is comprised of:
(A) about 5 to about 50 phr of precipitated silica and from 10 to about 50 phr of carbon black so long as the sealant layer is of a black color;
(B) from zero to about 20 phr of additional filler comprised of clay preferably kaolin clay, calcium carbonate, corn cob granules, or exfoliated intercalated water swellable clay platelets or their mixtures;
wherein said precipitated silica is comprised of:
(1) a pre-hydrophobated precipitated silica, or
(2) a combination of from about 5 to about 50 phr of pre-hydrophobated precipitated silica and from about 5 to about 50 phr of non pre-hydrophobated precipitated silica;
wherein said pre-hydrophobated precipitated silica is pre-hydrophobated by treatment of a precipitated silica with:
(3) a non-silane containing compound comprised of:
(a) dithiodipropoinic acid,
(b) trithiodipropionic acid,
(c) tetrathiodipropionic acid,
(d) 2-hydroxyethyl methacrylate,
(e) thioglycerol,
(f) benzothiazyl disulfide, or
(4) a combination of at least one of said non-silane containing compounds and an alkoxysilane containing compound comprised of at least one of an organoalkoxysilane compound and organomercaptoalkoxysilane compound.

18. The tire of claim 1 wherein said built-in puncture sealing layer is comprised of, based upon parts by weight per 100 parts by weight partially depolymerized butyl rubber (phr) of an organoperoxide partially depolymerized butyl rubber;
wherein said particulate reinforcing filler is comprised of:
(A) about 25 to about 100 phr of precipitated silica and from zero to about 5 phr of carbon black so long as the sealant layer is of a non-black color;
(B) from zero to about 20 phr of additional filler comprised of clay preferably kaolin clay, calcium carbonate, corn cob granules, or exfoliated intercalated water swellable clay platelets or their mixtures;
wherein said precipitated silica is comprised of:
(1) a pre-hydrophobated precipitated silica, or
(2) a combination of from about 5 to about 50 phr of pre-hydrophobated precipitated silica and from about 5 to about 50 phr of non pre-hydrophobated precipitated silica;
wherein said pre-hydrophobated precipitated silica is pre-hydrophobated by treatment of a precipitated silica with:
(3) a non-silane containing compound comprised of:
(a) dithiodipropoinic acid,
(b) trithiodipropionic acid,
(c) tetrathiodipropionic acid,
(d) 2-hydroxyethyl methacrylate,
(e) thioglycerol,
(f) benzothiazyl disulfide, or
(4) a combination of at least one of said non-silane containing compounds and an alkoxysilane containing compound comprised of at least one of an organoalkoxysilane compound and organomercaptoalkoxysilane compound

19. The tire of claim 1 wherein built-in puncture sealing layer is comprised of an organoperoxide partially depolymerized composite polymer network comprised of:
(A) about 50 to about 95 parts by weight organoperoxide partially depolymerized butyl rubber, and
(B) about 5 to about 50 parts by weight at least one of organoperoxide partially depolymerized cis 1,4-polyisoprene elastomer and organoperoxide partially depolymerized liquid polyisoprene polymer and their mixtures:
wherein said particulate reinforcing filler is comprised of:
(C) about 5 to about 50 phr of precipitated silica and from 10 to about 50 phr of carbon black so long as the sealant layer is of a black color;
(D) from zero to about 20 phr of additional filler comprised of clay preferably kaolin clay, calcium carbonate, corn cob granules, or exfoliated intercalated water swellable clay platelets or their mixtures;
wherein said precipitated silica is comprised of:
(E) a pre-hydrophobated precipitated silica, or
(F) a combination of from about 5 to about 50 phr of pre-hydrophobated precipitated silica and from about 5 to about 50 phr of non pre-hydrophobated precipitated silica;
wherein said precipitated silica is comprised of:
(G) a pre-hydrophobated precipitated silica, or
(H) a combination of from about 5 to about 30 phr of pre-hydrophobated precipitated silica and from about 5 to about 30 phr of non pre-hydrophobated precipitated silica;
wherein said pre-hydrophobated precipitated silica is pre-hydrophobated by treatment of a precipitated silica with:
(I) a non-silane containing compound comprised of:
(1) dithiodipropoinic acid,
(2) trithiodipropionic acid,
(3) tetrathiodipropionic acid,
(4) 2-hydroxyethyl methacrylate,
(5) thioglycerol,
(6) benzothiazyl disulfide, or
(J) a combination of at least one of said non-silane containing compounds and an alkoxysilane containing compound comprised of at least one of an organoalkoxysilane compound and organomercaptoalkoxysilane compound, and
(K) a bis(3-trialkoxysilylalkyl)polysulfide having an average of from 2 to about 4, alternately an average of from about 2 to about 2.6 or an average of from about 3.4 to about 3.8, connecting sulfur atoms in its polysulfidic bridge.

20. The tire of claim 1 wherein built-in puncture sealing layer is comprised of an organoperoxide partially depolymerized composite polymer network comprised of:
(A) about 50 to about 95 parts by weight organoperoxide partially depolymerized butyl rubber, and
(B) about 5 to about 50 parts by weight at least one of organoperoxide partially depolymerized cis 1,4-polyisoprene elastomer and organoperoxide partially depolymerized liquid polyisoprene polymer and their mixtures:
wherein said particulate reinforcing filler is comprised of:
(C) about 25 to about 100 phr of precipitated silica and from zero to about 5 phr of carbon black so long as the sealant layer is of a non-black color;
(D) from zero to about 20 phr of additional filler comprised of clay preferably kaolin clay, calcium carbonate, corn cob granules, or exfoliated intercalated water swellable clay platelets or their mixtures;
wherein said precipitated silica is comprised of:
(E) a pre-hydrophobated precipitated silica, or
(F) a combination of from about 5 to about 50 phr of pre-hydrophobated precipitated silica and from about 5 to about 50 phr of non pre-hydrophobated precipitated silica;
wherein said pre-hydrophobated precipitated silica is pre-hydrophobated by treatment of a precipitated silica with:
(G) a non-silane containing compound comprised of:
(1) dithiodipropoinic acid,
(2) trithiodipropionic acid,
(3) tetrathiodipropionic acid,
(4) 2-hydroxyethyl methacrylate,
(5) thioglycerol,
(6) benzothiazyl disulfide, or
(7) a combination of at least one of said non-silane containing compounds and an alkoxysilane containing compound comprised of at least one of an organoalkoxysilane compound and organomercaptoalkoxysilane compound, and
(H) a bis(3-trialkoxysilylalkyl)polysulfide having an average of from 2 to about 4, alternately an average of from about 2 to about 2.6 or an average of from about 3.4 to about 3.8, connecting sulfur atoms in its polysulfidic bridge.
